(19) United States
(12) Patent Application Publication
(10) Pub. No.: US 2011/0103370 A1
(43) Pub. Date: May 5, 2011

(54) CALL MONITORING AND HUNG CALL PREVENTION

(75) Inventors: Jacob Igval, Newtown, PA (US); Christopher J. Cotignola, Doylestown, PA (US)

(73) Assignee: General Instruments Corporation, Horsham, PA (US)

(21) Appl. No.: 12/608,599

(22) Filed: Oct. 29, 2009

(51) Int. Cl. H04L 12/66; G10L 11/06

(52) U.S. Cl. 370/352; 704/210; 704/E11.003

(57) ABSTRACT

A hung call system includes a memory storing samples of voice data from packets for a VoIP call. A voice activity detector detects whether the stored voice data includes a voice from one or more parties to the call. A processing circuit determines whether the voice activity detector detects the voice, and the processing circuit facilitates release of the call if the voice activity detector does not detect the voice for a predetermined period of time.

### BACKGROUND

Hung calls present a problem for voice-over-Internet-Protocol (VoIP) systems. VoIP is the delivery of voice communications over a packet-switched network. A hung call is a call with no voice traffic or one-way voice traffic, such as voice traffic from only one party to a call. Voice traffic is comprised of packets carrying voice data for voice communications from parties to the call.

A hung call may be caused by different situations. For example, a hung call may be caused by one party hanging up but the other party remaining on the call by forgetting to hang up. In this situation, if one or more of the parties to the call forget to hang up, packets may continue to flow between parties to the call. The packets may include audio data comprised of background noise, for example, from a TV or radio, but not voice from parties to the call.

Another common cause is when a call management system (CMS) is not notified that a call is terminated. For example, VoIP devices at the customer premises, such as a multimedia terminal adapter (MTA) or an embedded multimedia terminal adapter (EMTA), which includes a cable modem, should detect an on-hook signal when a phone is hung up and notify the CMS. The CMS then instructs the VoIP device to release the call, and then the bandwidth allocated to the call is released and made available for another call. However, if the VoIP device does not detect the on-hook signal even though the phone is hung-up, the call is not released and the bandwidth remains reserved for the call even though the call is done. Note that the VoIP device typically must wait for a message from the CMS in order to release the call. Thus, any situation where the CMS fails to signal the CPE to release the call even though the call is done, tends to result in a hung call.

When hung calls accumulate, bandwidth that is allocated or otherwise reserved for the hung calls is not released and made available for new VoIP calls or other traffic and services requiring committed bandwidth. This situation can cause failure of a CMS and/or a cable modem termination system (CMTS) and may result in dropped calls, inability to establish new calls or other degradation of service.

### SUMMARY

According to an embodiment, a hung call system includes a memory storing samples of voice data from packets for a VoIP call. A voice activity detector detects whether the stored voice data includes a voice from one or more parties to the call. A processing circuit determines whether the call is a hung call based on information from the voice activity detector. The processing circuit facilitates release of the call if the call is a hung call.

The hung call system allows bandwidth and resources for a hung call to be released and made available for other calls or other traffic and services. In one example, a CMS commands a CMTS, VoIP devices, and/or other devices to allocate bandwidth and resources for the call. Thus, the devices being commanded by the CMS to allocate bandwidth and resources may fail as a result of accumulation of hung calls. By releasing the hung calls, these devices are less susceptible to failure.

### BRIEF DESCRIPTION OF THE DRAWINGS

Embodiments are illustrated by way of example and not limited in the following Figure(s), in which like numerals indicate like elements, in which:

FIG. 1 illustrates a communications system, according to an embodiment;

FIG. 2 illustrates a hung call system, according to an embodiment; and

FIG. 3 illustrates a flowchart of a method for detecting a hung call, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the description of the embodiments. Furthermore, multiple embodiments are disclosed and the embodiments may be used singly or in various combinations.

According to an embodiment, a hung call system is configured to detect hung VoIP calls and facilitate termination of hung calls so their allocated bandwidth can be freed for new calls or for other traffic. In one embodiment, the hung call system includes a voice recognition system that monitors voice traffic and can performs pattern recognition on voice data. The voice recognition system detects if no voice traffic is generated by the call (e.g., both parties to a call hung up) or if traffic is only coming from one party (e.g., only one party to the call hung up). If any of these conditions are detected, the hung call system notifies a call management system that the call is terminated. The hung call system may be provided in a VoIP device at a customer premises, such as a user's home, user's office, or other location of a user. The hung call system may be included in or connected to a VoIP device or customer premises equipment (CPE). A VoIP device may include a modem, an MTA, an EMTA, or some other device that allows CPE to make and receive voice calls. The CPE may include phones, a fax machine, a personal computer, a set top box, or other equipment at the customer premises.

The hung call system is configured to detect a hung call caused by a loss of packet traffic. Also, the hung call system is configured to detect a hung call whereby voice traffic is still flowing between parties but the users intended to terminate the call. This situation is more difficult to detect than a loss of traffic. When a hung call is detected, the hung call system takes action to facilitate release of the hung call. In one embodiment, the hung call system may use an existing platform, such as a digital signal processor (DSP) in a modem or EMTA or gateway/switch.

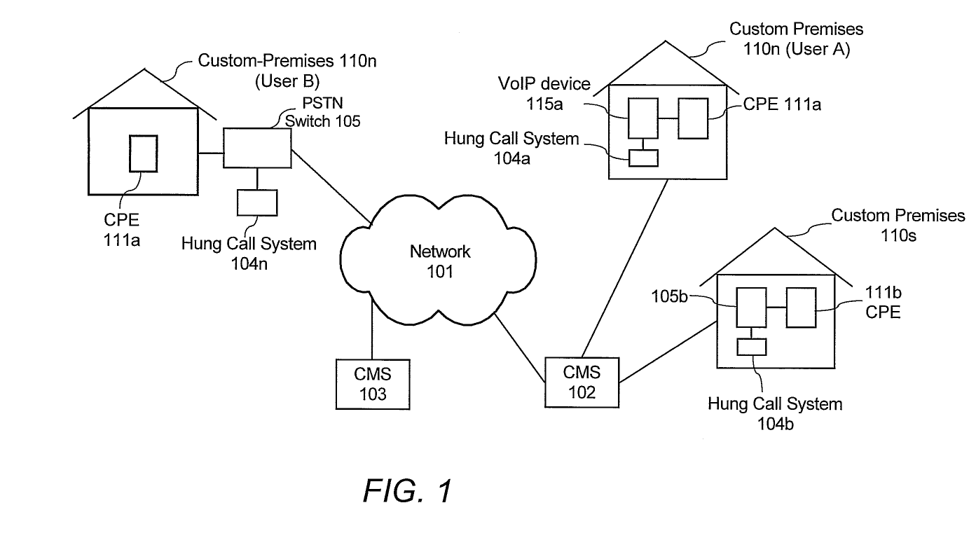

FIG. 1 illustrates a communications system 100, according to an embodiment. The system 100 is operable to establish VoIP calls between parties including a caller and a callee. The system 100 includes customer premises 110a-n that may communicate through VoIP calls via a network 101. The system 100 also includes hung call systems 104a-n that detect a facilitate release of hung calls as is further described below.

The network 101 may include a circuit-switched network (e.g., PSTN), a packet-switched network, which may be public and/or private (e.g., the Internet, a service provider network, cable network, CATV, hybrid-fiber coaxial, fiber-to-the-curb, passive optical network), and/or other types of networks. The network 101 may include a mobile phone network.

The customer premises 110a-n include CPE 111a-n. The customer premises may include VoIP devices, such as a modem, an MTA, an EMTA, etc., for making and receiving VoIP calls. VoIP devices 115a-b are shown for customer premises 110a-b. Some customer premises, such as customer premises 110n, may not include a VoIP device but can make and receive calls through a public-switched telephone network (PSTN) switch 105. The PSTN switch 105 may convert VoIP packets to call information that can be transmitted on a PSTN to the customer premises 110n.

The system 100 may include a CMTS 102. For example, the network 101 includes a cable service provider network, and the CMTS is part of the network. The service provider uses the CMTS 102 to provide high-speed data services to the customer premises 110a and 110b. For example, the CMTS 102 may be included in a headend and connects VoIP devices 115a-b in the customer premises 110a-b to the Internet. VoIP services are provided to the customer premises 110a-b via the CMTS 102.

The system 100 includes a CMS 103 to establish VoIP calls between parties. For example, a user A at customer premises 110a wants to make a VoIP call to a user B at customer premises 110n. The user A picks up the phone and dials the telephone number of the user B. The VoIP device 115a sends a request to the CMS 103 to establish a call. The CMS 103 establishes the call by assigning bandwidth to the call. A data over cable protocol (e.g., DOCSIS) or some other protocol may be used to establish a data path between parties to a VoIP call, and then a protocol (e.g., PacketCable protocol) may be used to establish voice calls on the data path. The CMS 103 may use the PacketCable protocol or some other protocol to create and release VoIP calls.

The CMS 103 assigns bandwidth for a VoIP call and releases the call if the CMS 103 receives a message that the call is terminated. In one example, the CMS 103 commands the CMTS, VoIP devices, and/or other devices to allocate bandwidth and resources for the call. Thus, the devices being commanded by the CMS 103 to allocate bandwidth and resources may fail as a result of accumulation of hung calls. By releasing the hung calls, these devices are less susceptible to failure. Releasing a call includes releasing the bandwidth allocated for the call so the bandwidth may be used for other calls or other traffic and services. The CMS 103 signals a VoIP device to release the call and then the call is released. DOCSIS may be used to establish data path in the network 101 for a VoIP call and the PacketCable protocol may be used to create voice path over the data path for the VoIP call. The system 100 is intended to be a very general case. The system 100 may include other features than shown and may include redundant features.

The system 100 includes the hung call systems 104a-c configured to detect hung calls and facilitate release of hung calls, according to an embodiment. The hung call systems 104a-c may be included in or connected VoIP devices, which may be VoIP devices at the customer premises or outside the customer premises. For example, the hung call systems 104a-b may be located in or connected to the VoIP devices 115a-b and the hung call system 104c may be located in the PSTN switch 105, which may be gateway including DSPs or other processing circuits.

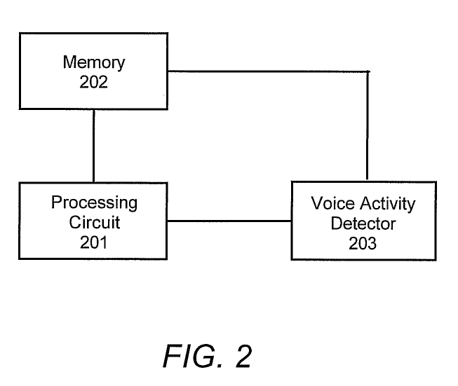

FIG. 2 illustrates a hung call system 200 that may be used for the hung call systems 104a-c. The hung call system 200 includes processing circuit 201 (e.g., DSP, processor, etc.), memory 202, and a voice activity detector 203. The memory 202 stores samples of voice data from voice traffic. The voice traffic includes packet carrying voice data for parties to a VoIP call.

The voice activity detector 203 analyzes the voice data in the memory 202 to determine whether the voice data includes audio from parties to the call. The voice activity detector 203 may perform frequency analysis or other known analysis techniques on the voice data to determine whether the voice data includes voices of parties to the call. A conventional voice activity detector may be used for the voice activity detector 203. Speech recognition is known in the art. In general, speech audio input is digitized and then processed to facilitate identification of words versus background noise. U.S. Pat. No. 7,024,353, by Ramabadran et al., and assigned to Motorola, Inc., discloses a voice activity detector including a voice activity determiner 39 that may be used for the voice activity detector 203. U.S. Pat. No. 7,024,353 is incorporated by reference in its entirety.

The voice activity detector 203 may generate an output signal indicating whether the sampled voice data includes voice activity from any of the parties to the call. Background noise that is not from a party to the call, such as a radio or television in the background, is not indicated as voice activity. However, if multiple parties are on the call, a voice from any of the parties is indicated as voice activity.

Also, the voice activity detector 203 can detect voice activity from incoming as well as outgoing packets. For example, if the voice activity detector 203 is in the customer premises 110a shown in FIG. 1 and is monitored voice data from a call between user A and user B in customer premises 110n, then the voice activity detector 203 can determine whether the voice activity is from user A or user B, for example, from pattern recognition or by identifying whether the source of the voice data is from a packet from user B or from voice data from user A.

The processing circuit 201 uses the output of the voice activity detector 203 to determine whether there is any voice activity from the parties to the call. The processing circuit 201 determines whether there is no voice activity from the parties for a predetermined period of time. The processing circuit 201 also determines whether voice traffic is flowing for the call. For example, the processing circuit 201 determines whether voice packets are being received for the call. The packets may include an identifier that indicates the packets are for the call. If the processing circuit 201 determines there is no voice activity from the parties for the predetermined period of time but the call is active (e.g., VoIP connection is established between parties and/or voice traffic is flowing), then the processing circuit 201 determines that the call is a hung call. A hung call is thus detected.

In response to detecting a hung call, the hung call system 200 facilitates release of the call. For example, the processing circuit 201 facilitates release of the call by sending a message to a higher layer authority, such as the CMS 103 and/or the CMTS 102, to release the call. The processing circuit 201 may send a message to an error logging system, which may be automatically or manually monitored to determine whether there is any hung calls or other errors in the communication system. As a result, the hung call is released and the bandwidth and other resources are freed for new calls. In another example, the hung call system facilitates release by playing a message to the user indicating that the call will be terminated or indicating to the user to hang up the phone.

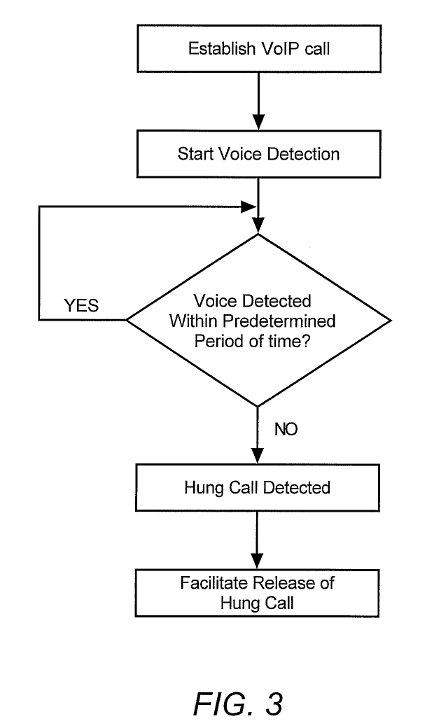

FIG. 3 illustrates a method 300 according to an embodiment for detecting a hung call. One or more steps of the method 300 may be performed but the hung call system 200. At step 301, a VoIP call is established between at least two parties. For example, signaling is performed between the parties and the CMS 103 shown in FIG. 1 to establish a VoIP call. The CMS 103 allocates bandwidth for the call.

At step 302, voice detection for any of the parties is started. For example, the voice activity detector 203 determines whether voice activity is detected for any of the parties to the call.

At step 303, a determination is made as to whether voice from any of the parties is detected within a predetermined period of time. For example, the processing circuit 201 determines whether the voice activity detector 203 detected voice from any of the parties within the predetermined period of time. The voices from parties to the call include voices from the people intended to be on the call. This may not include background noise or background voices from people not intended to be on the call, which can result from one or more of the parties forgetting to hang up. In this case, the voice traffic flowing between the parties would include audio from the background but not from the people intended to be on the call. The voice activity detector 203 can use sampling, frequency analysis and pattern matching to identify the voices from the people on the call and can distinguish between the voices of the people intended to be on the call and background noise.

At step 304, if the voice is not detected within the predetermined period of time, the call is determined to be a hung call. For example, voice traffic for the call is sampled. A 3 minute interval passes whereby the voice activity detector 203 does not detect voice activity from any of the parties. The processing circuit 201 then assumes the call is a hung call. The voice activity detector 203 or the processor 201 may also detect if voice traffic for the call stopped flowing for the predetermined period of time, and then the call is considered a hung call. For example, the voice traffic may include packets that have an identifier that identifies the packets for a VoIP call. If these packets are not received for the predetermined period of time, the call is considered to be a hung a call.

At step 304, no voice activity from any of the parties may be detected before any voice traffic for the call is flowing but after the call is established. A call may become hung even before voice traffic initially starts flowing, and the hung call system can detect this situation. Also, at step 304, after the voice traffic was initially flowing, the call may become hung, when the voice traffic stops at least for the predetermined period of time. The hung call system can detect this situation also.

At step 305, release of the call is facilitated if a hung call is detected. For example, the processing circuit 201 facilitates release of the call by sending a message to the CMS 103 and/or the CMTS 102 to release the call. The processing circuit 201 may send a message to an error logging system, which may be automatically or manually monitored to determine whether there is any hung calls or other errors in the communication system. As a result, the hung call is released and the bandwidth and other resources are freed for new calls. In another example, the hung call system facilitates release by playing a message to the user indicating that the call will be terminated or indicating to the user to hang up the phone.

One or more of the steps in the method 300 and other steps and functions described herein may be implemented as software embedded or stored on a computer readable storage device and executed by a processing circuit. For example, the hung call system 200 may include software stored in memory that is executed by a processor or a DSP.

Also, the hung call system 200 may be incorporated in a VoIP device. For example, the hung call system 200 may be included in a cable modem or an EMTA, and the processing circuit 201 may be a DSP or processor in the VoIP device and the memory 202 may be part of the VoIP device. In another example, the VoIP device comprises a DSP in a gateway, such as the PSTN switch 105. The DSP may be part of a farm of DSPs in the gateway servicing many customers. The hung call system 200 may include an agent running on the VoIP device.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A hung call system comprising:
memory configured to store samples of voice data from packets for a VoIP call;
a voice activity detector configured to detect whether the stored samples of voice data include a voice from one or more parties to the call; and
a processing circuit configured to determine whether the voice activity detector detects the voice, wherein the processing circuit facilitates release of the call if the voice activity detector does not detect the voice for a predetermined period of time.

2. The hung call system of claim 1, wherein the processing circuit determines the call is hung if the voice activity detector does not detect the voice for the predetermined period of time.

3. The hung call system of claim 1, wherein the processing circuit determines the call is hung if the voice activity detector does not detect the voice for the predetermined period of time and the packets for the VoIP call are being received.

4. The hung call system of claim 1, wherein the call is released if bandwidth reserved for the call is released for use for a new call or other traffic.

5. The hung call system of claim 1, wherein the processing circuit facilitates release of the call by sending a message to a call management server to release the call.

6. The hung call system of claim 1, wherein the processing circuit facilitates release of the call by sending an error message to a logging system to release the call.

7. The hung call system of claim 1, wherein the processing circuit facilitates release of the call by sending an error message to a CMTS to release the call.

8. The hung call system of claim 1, wherein the processing circuit determines whether voice activity is detected for the one or more parties to the call after the call is established and prior to receiving any packets for the call.

9. The hung call system of claim 1, wherein the processing circuit is provided in an EMTA or an MTA.

10. The hung call system of claim 1, wherein the processing circuit is provided in a PSTN switch.

11. The hung call system of claim 1, wherein the processing circuit is a DSP or a processor.

12. A method for detecting a hung call, the method comprising:
establishing a VoIP call between at least two parties;
starting voice detection for any of the at least two parties;
determining whether a voice from any of the at least two parties is detected within a predetermined period of time; and
if the voice is not detected within the predetermined period of time, facilitating release of the VoIP call.

13. The method of claim 12, further comprising releasing the VoIP call wherein the releasing includes releasing bandwidth allocated for the call to allow the bandwidth to be used for a new call or other traffic.

14. The method of claim 12, wherein facilitating release of the VoIP call comprises:
facilitates release of the VoIP call by sending a message to a call management server to release the VoIP call.

15. The method of claim 12, wherein facilitating release of the VoIP call comprises:
sending an error message to a logging system to release the VoIP call.

16. The method of claim 12, wherein facilitating release of the VoIP call comprises:
sending an error message to a CMTS to release the VoIP call.

17. The method of claim 12, wherein determining whether a voice from any of the at least two parties is detected within a predetermined period of time further comprises:
determining whether the voice from any of the at least two parties is detected within the predetermined period of time after the VoIP call is established and prior to receiving any packets for the VoIP call.

18. The method of claim 12, wherein determining whether a voice from any of the at least two parties is detected within a predetermined period of time further comprises:
determining whether the voice from any of the at least two parties is detected within the predetermined period of time after the VoIP call is established and after voice traffic for the VoIP call is flowing.

19. A VoIP device configured to facilitate detection of a hung call, the VoIP device comprising:
memory configured to store samples of voice data from packets for a VoIP call;
a voice activity detector configured to detect whether the stored samples of voice data include a voice from one or more parties to the VoIP call; and
a processing circuit configured to determine whether the voice activity detector detects the voice, wherein the processing circuit facilitates release of the VoIP call if the voice activity detector does not detect the voice for a predetermined period of time.

20. The VoIP device of claim 19, wherein the processing circuit comprises a DSP in a cable modem or an EMTA or a gateway.
